(19) United States
(12) Patent Application Publication
(10) Pub. No.: US 2002/0092980 A1
(43) Pub. Date: Jul. 18, 2002

(54) Method and apparatus for a multipole ion trap orthogonal time-of-flight mass spectrometer

(76) Inventor: Melvin A. Park, Billerica, MA (US)

Correspondence Address: Ward & Olivo, 708 Third Avenue, New York, NY, 10017, US

(21) Appl. No.: 09/765,251

(22) Filed: Jan. 18, 2001

(51) Int. Cl. H01J 49/00; B01D 59/44

(52) U.S. Cl. 250/288

(57) ABSTRACT

The invention relates to means and methods for the orthogonal introduction of ions into a TOF mass spectrometer, whereby ions from an ion source can be efficiently transferred via a multipole ion guide such that they can be readily analyzed in a TOF analyzer. The invention includes first introducing ions into an ion guide, preferably an RF/DC ion guide, which guides the ions into a multipole ion trap. Both the ion guide and ion trap are preferably orthogonal to the flight direction of the TOF mass spectrometer. By changing the potentials on the electrodes of the multipole ion trap, the ions may be extracted from the trap in the direction of the flight region. Also, in accordance with the invention, the entrance region of the ion guide is held at moderate pressure to cool the ions to thermal energies. These ions are cooled due to collisions with neutral background gas molecules, thus lowering the energy spread of the ions. Preferably, the invention uses different DC and RF electrodes to trap and extract ions. By minimizing the energy spread of the ions, the invention results in improved performance of any TOF mass spectrometer.

### TECHNICAL FIELD OF THE INVENTION

The present invention relates generally to means and method whereby ions can be transferred efficiently from an ion source in such a way that can be readily analyzed in a time-of-flight (TOF) mass spectrometer. More specifically, an apparatus is described which uses an ion trap and a multipole ion guide to obtain higher resolution from an orthogonal TOF mass spectrometer.

### BACKGROUND OF THE PRESENT INVENTION

The apparatus and methods for ionization described herein are enhancements of the techniques that are referred to in the literature relating to mass spectrometry. Mass spectrometry is an important tool in the analysis of a wide range of chemical compounds. Specifically, mass spectrometers can be used to determine the molecular weight of sample compounds. The analysis of samples by mass spectrometry consists of three main steps—formation of gas phase ions from sample material, mass analysis of the ions to separate the ions from one another according to ion mass, and detection of the ions. A variety of means exist in the field of mass spectrometry to perform each of these three functions. The particular combination of means used in a given spectrometer determine the characteristics of that spectrometer.

To mass analyze ions, for example, one might use a magnetic (B) or electrostatic (E) analyzer. Ions passing through a magnetic or electrostatic field will follow a curved path. In a magnetic field the curvature of the path will be indicative of the momentum-to-charge ratio of the ion. In an electrostatic field, the curvature of the path will be indicative of the energy-to-charge ratio of the ion. If magnetic and electrostatic analyzers are used consecutively, then both the momentum-to-charge and energy-to-charge ratios of the ions will be known and the mass of the ion will thereby be determined. Other mass analyzers are the quadrupole (Q), the ion cyclotron resonance (ICR), the time-of-flight (TOF), and the quadrupole ion trap analyzers. The analyzer which accepts ions from the ion guide described here may be any of a variety of these.

Before mass analysis can begin, however, gas phase ions must be formed from sample material. If the sample material is sufficiently volatile, ions may be formed by electron ionization (EI) or chemical ionization (CI) of the gas phase sample molecules. For solid samples (e.g. semiconductors, or crystallized materials), ions can be formed by desorption and ionization of sample molecules by bombardment with high energy particles. Secondary ion mass spectrometry (SIMS), for example, uses keV ions to desorb and ionize sample material. In the SIMS process a large amount of energy is deposited in the analyte molecules. As a result, fragile molecules will be fragmented. This fragmentation is undesirable in that information regarding the original composition of the sample—e.g., the molecular weight of sample molecules—will be lost.

For more labile, fragile molecules, other ionization methods now exist. The plasma desorption (PD) technique was introduced by Macfarlane et al. in 1974 (Macfarlane, R. D.; Skowronski, R. P.; Torgerson, D. F., Biochem. Biophys. Res Commoun. 60 (1974) 616). Macfarlane et al. discovered that the impact of high energy (MeV) ions on a surface, like SIMS would cause desorption and ionization of small analyte molecules, however, unlike SIMS, the PD process results also in the desorption of larger, more labile species—e.g., insulin and other protein molecules.

Lasers have been used in a similar manner to induce desorption of biological or other labile molecules. See, for example, VanBreeman, R. B.: Snow, M.: Cotter, R. J., Int. J. Mass Spectrom. Ion Phys. 49 (1983) 35; Tabet, J. C.; Cotter, R. J., Anal. Chem. 56 (1984) 1662; or Olthoff, J. K.; Lys, I.: Demirev, P.: Cotter, R. J., Anal. Instrument. 16 (1987) 93. Cotter et al. modified a CVC 2000 time-of-flight mass spectrometer for infrared laser desorption of involatile biomolecules, using a Tachisto (Needham, Mass.) model 215G pulsed carbon dioxide laser. The plasma or laser desorption and ionization of labile molecules relies on the deposition of little or no energy in the analyte molecules of interest. The use of lasers to desorb and ionize labile molecules intact was enhanced by the introduction of matrix assisted laser desorption ionization (MALDI) (Tanaka, K.; Waki, H.; Ido, Y.; Akita, S.; Yoshida, Y.; Yoshica, T., Rapid Commun. Mass Spectrom. 2 (1988) 151 and Karas, M.; Hillenkamp, F., Anal. Chem. 60 (1988) 2299). In the MALDI process, an analyte is dissolved in a solid, organic matrix. Laser light of a wavelength that is absorbed by the solid matrix but not by the analyte is used to excite the sample. Thus, the matrix is excited directly by the laser, and the excited matrix sublimes into the gas phase carrying with it the analyte molecules. The analyte molecules are then ionized by proton, electron, or cation transfer from the matrix molecules to the analyte molecules. This process, MALDI, is typically used in conjunction with time-of-flight mass spectrometry (TOFMS) and can be used to measure the molecular weights of proteins in excess of 100,000 daltons.

Atmospheric pressure ionization (API) includes a number of methods. Typically, analyte ions are produced from liquid solution at atmospheric pressure. One of the more widely used methods, known as electrospray ionization (ESI), was first suggested by Dole et al. (M. Dole, L. L. Mack, R. L. Hines, R. C. Mobley, L. D. Ferguson, M. B. Alice, J. Chem. Phys. 49, 2240, 1968). In the electrospray technique, analyte is dissolved in a liquid solution and sprayed from a needle. The spray is induced by the application of a potential difference between the needle and a counter electrode. The spray results in the formation of fine, charged droplets of solution containing analyte molecules. In the gas phase, the solvent evaporates leaving behind charged, gas phase, analyte ions. Very large ions can be formed in this way. Ions as large as 1 MDa have been detected by ESI in conjunction with mass spectrometry (ESMS).

Many other ion production methods might be used at atmospheric or elevated pressure. For example, MALDI has recently been adapted by Victor Laiko and Alma Burlingame to work at atmospheric pressure (Atmospheric Pressure Matrix Assisted Laser Desorption Ionization, poster #1121, 4^{th} International Symposium on Mass Spectrometry in the Health and Life Sciences, San Francisco, Aug. 25-29, 1998) and by Standing et al. at elevated pressures (Time of Flight Mass Spectrometry of Biomolecules with Orthogonal Injection+Collisional Cooling, poster #1272, 4^{th} International Symposium on Mass Spectrometry in the Health and Life Sciences, San Francisco, Aug. 25-29, 1998; and Orthogonal Injection TOFMS Anal. Chem. 71(13), 452A (1999)). The benefit of adapting ion sources in this manner is that the ion optics and mass spectral results are largely independent of the ion production method used.

An elevated pressure ion source always has an ion production region (wherein ions are produced) and an ion transfer region (wherein ions are transferred through differential pumping stages and into the mass analyzer). The ion production region is at an elevated pressure—most often atmospheric pressure—with respect to the analyzer. The ion production region will often include an ionization “chamber” (e.g. FIG. 1, ionization chamber 4). In an ESI source, for example, liquid samples are “sprayed” into the “chamber” to form ions.

Once the ions are produced, they must be transported to the vacuum for mass analysis. Generally, mass spectrometers (MS) operate in a vacuum between 10⁻⁴ and 10⁻¹⁰ torr depending on the type of mass analyzer used. In order for the gas phase ions to enter the mass analyzer, they must be separated from the background gas carrying the ions and transported through the single or multiple vacuum stages.

The use of multipole ion guides has been shown to be an effective means of transporting ions through vacuum regions. Publications by Olivers et. al. (Anal. Chem, Vol. 59, p. 1230-1232, 1987), Smith et. al. (Anal. Chem. Vol. 60, p. 436-441, 1988) and U.S. Pat. No. 4,963,736 (1990) have reported the use of an AC only quadrupole ion guide to transport ions from an API source to a mass analyzer. A quadrupole ion guide operated in RF only mode, configured to transport ions is described by Douglas et. al in U.S. Pat. No. 4,963,736. Multipole ion guides configured as collision cells are operated in RF only mode with a variable DC offset potential applied to all rods. Thomson et. al. in U.S. Pat. No. 5,847,386 describes a multipole ion guide assembly configured to create a DC electric field along the ion guide axis to move ions axially through a collision cell or to promote Collision Induced Dissociation (CID) fragmentation.

Other schemes are available, which utilize both RF and DC potentials in order to facilitate the transmission of ions of a certain range of m/z values. For example, Morris et al., in H. R. Morris et al., High Sensitivity Collisionally-Activated Decomposition Tandem Mass Spectrometry on a Novel Quadrupole/Orthogonal-acceleration Timon-of-Flight Mass Spectrometer, Rapid Commun. Mass Spectrom. 10, 889 (1996), uses a series of multipoles in their design, one of which is a quadrupole. The quadrupole can be run in a “wide bandpass” mode or a “narrow bandpass” mode. In the wide bandpass mode, an RF-only potential is applied to the quadrupole and ions of a relatively broad range of m/z values are transmitted. In narrow bandpass mode both RF and DC potentials are applied to the quadrupole such that ions of only a narrow range of m/z values are selected for transmission through the quadrupole. In subsequent multipoles the selected ions may be activated towards dissociation. In this way the instrument of Morris et al. is able to perform MS/MS with the first mass analysis and subsequent fragmentation occurring in what would otherwise be simply a set of multipole ion guides.

Time-of-flight mass spectrometry (or TOFMS) plays an important role in the analysis of chemical compounds. Specifically, TOF mass spectrometers are useful in determining the molecular weight of sample compounds. In orthogonal TOF mass spectrometers ions pass from the source into the analyzer in a direction which is orthogonal to the axis of the analyzer. The concept of orthogonal acceleration using TOFMS was disclosed by O'Hallran et al. in 1964 (G. J. O'Halloran et al., Determination of Chemical Species Prevalent in a Plasma Jet. Technical Documentary Report No. ASD-TDR-62-664, prepared under contract AF 33(616)-8374 by the Bendix Corp. Research Laboratories (1964)). O'Hallran et al. also introduced the application of TOF mass analysis to ionization sources at elevated pressure. One advantage to using orthogonal acceleration and elevated pressure ionization sources is that ions form a continuous beam and can be mass analyzed more efficiently. Also, with the “orthogonal acceleration” method, the mass analysis occurs along an axis which is orthogonal to the ion's initial direction of motion. As a result, the initial energy of the ions does not significantly degrade the mass resolution of the instrument.

Chien and Lubman demonstrated the advantage of using a quadrupole ion trap—TOF mass analyzer in the analysis of electrospray produced ions (Chien, B. M.; Lubman, D. M., Anal. Chem. 66, 1630 (1994)). The ions from the electrospray source are transferred with a high efficiency to the TOF analyzer and ions may be preselected and collision induced dissociation on these ions may be performed. One disadvantage with this method is low mass resolving power. Also, there are restrictions in the time required for cooling the ions and cycling the pressure in the ion trap.

Chernushevich et al discloses the use of ion introduction into an RF-quadrupole ion guide at a high gas pressure (I. V. Chernushevich, Proceedings of the 44th ASMS Conference of Mass Spectrometry and Allied Topics, May 12-16, 1173 (1996)). Similarly, Douglas discloses ion introduction into a quadrupole ion trap rather than a TOF analyzer (D. J. Douglas, U.S. Pat. No. 5,179,278). Here, the ions are cooled by passage through the quadrupole ion trap at elevated pressure and are transferred into a low pressure region containing the TOF analyzer. This “collisional focusing” method can be incorporated with the “orthogonal acceleration” method to obtain a higher resolution mass spectra.

Morris et al. discloses the use of additional multipole devices to preselect ions and induce collision dissociation in the trap—TOF analyzer (H. R. Morris et al., Rapid Comm. Mass Spectrom. 10, 889 (1996)). Collision induced dissociation experiments were disclosed in Lubman (B. M. Chien, S. M. Michael, D. M. Lubman, Int J. Mass Spectrom. Ion Process., 131, 149 (1994), B. M. Chien, D. M. Lubman, Anal. Chem. 66, 1630 (1994)). There first multipole device is used to cool ions then a second multipole is used for mass selection, and a third multipole is used for collision induced dissociation.

In orthogonal TOF mass spectrometer of the invention, ions are trapped in a multipole ion guide having an apertured electrode at its exit. By applying a repelling potential to the electrode, ions near the exit of the multipole are reflected back into the guide for trapping. During analysis, the potential of the electrode is pulsed so that, during the duration of the pulse (20-100 us), ions may exit the multipole.

Also, ions extracted from a multipole device and orthogonally accelerated to the direction of the axis of the analyzer will have a significant kinetic energy orthogonal to the axis of the analyzer. This initial kinetic energy will cause the ions to drift perpendicularly to the analyzer axis. This kinetic energy must be accounted for in order to prevent ion loss and to ensure ion detection. Also, during the extracting process, accelerated ions will have its kinetic energy component increased in the direction axial to the multipole. As the ions enter the accelerator of the analyzer, the axial energy component will result in a decreased mass resolution.

High efficiency in transmitting ions from the multipole to the analyzer will require the spatial extent of the ion beam perpendicular to the axis of the analyzer to be large compared to that of prior art designs. As a result, some prior art devices (i.e. the two stage reflectron taught by R. Frye in U.S. Pat. No. 4,731,532) cannot be used with the orthogonal multipole TOF device described above.

An alternative “method and device for orthogonal ion injection into a time-of-flight mass spectrometer” was proposed in Franzen U.S. Pat. No. 5,763,878 (the “'878 patent”). According to the '878 patent, ions are ejected from a multipole ion guide of design similar to that of Chernushevich et al. into a time-of-flight analyzer and in a direction orthogonal to the axis of the multipole device. In trapping mode an RF potential is applied to the poles of the multipole device whereas in ejection mode, DC potentials are applied to the poles of the multipole device so as to accelerate the ions in a direction orthogonal to the axis of the multipole device and parallel to the axis of the TOF analyzer.

As shown in FIGS. 1 & 2, the '878 patent discloses multipole devices having six poles (FIG. 1, elements 122-127) or four poles (FIG. 2, elements 132-135) to trap and eject ions. Although the spectrometer according to the '878 patent has certain advantages over prior art, it is not ideal. One disadvantage of the spectrometer according to the '878 patent is that the multipole device of the '878 patent has a limited mass-to-charge (“m/z”) range. The m/z range of the device can be improved by increasing the number of poles used—for example, eight or more could be used instead of the four or six poles used by the '878 patent. Using more poles distributed in roughly a circular pattern around the axis of the multipole would improve the m/z range of the device while in trapping mode. However, when ejecting ions from the device, the DC potential applied to each pole would have to be controlled independently. Thus, in ejection mode, having a large number of poles would be impractical.

Also, according to the '878 patent, the arrangement of electrodes in the multipole is not ideal for the acceleration of ions into a TOF analyzer. That is, it is difficult to produce a uniform electrostatic field which accelerates ions in a direction orthogonal to the hexapole. The electric field strength and direction of acceleration of the ions during extraction from multipole device of the '878 patent is dependent on the ion's position within the multipole device. The electrostatic field produced in an ideal TOF ion accelerator is completely homogeneous. In other words, the electrostatic field strength and the direction in which the ions are accelerated is not a function of position within the accelerator.

FIG. 1 shows a section through a prior art Ion Trap in the form of a hexapole with Pole Rods (122) to (127). The hexapole arrangement is located between the Ion Repeller (121) and the Ion Drawing Diaphragm (129), spaced about 12 millimeters from one another. The hexapole arrangement houses the Ion Cloud (128) formed as a thin thread which is made up of well-cooled ions. In storage conditions, one phase of the storage RF voltage is applied to Pole Rods (122), (124), and (126), and the other phase to Pole Rods (123), (125), and (127). Ions of both polarities can be stored. To outside positive ions, a more positive voltage is applied to Pole Rods (122) and (125), a more negative voltage to Rods (124) and (127) than to Rods (123) and (126). The Ion Drawing Diaphragm (129) is designed as a slit diaphragm through which all ions can be accelerated without loss. Slight beam divergences can be focused through the cylindrical Einzel Lens (130) into a parallel beam. Arrow (131) indicates the flight direction within the time-of-flight spectrometer.

FIG. 2 shows a quadrupole arrangement made up of Pole Rods (132) to (135). The pole rods are arranged asymmetrically here in order to cause outpulsing solely through the external electrical field between the Ion Repeller (121) and Ion Drawing Diaphragm (129), without special voltages on the Pole Rods (132) to (135), the RF voltage of which is simply switched off.

Also, the multipole device according to Franzen stores ions in only one dimension. In particular, the '878 patent states that “ions must be stored in the form of a thin thread in the axis” of the multipole device. This substantially limits the number of ions which can be stored in the device without encountering space charge effects.

### SUMMARY OF THE INVENTION

An object of the present invention is to provide an improved method and apparatus for a multipole ion guide and trap (i.e., quadrupole, hexapole, octapole, etc.) for use in orthogonal TOFMS. Specifically, the multipole ion trap-orthogonal time of flight mass spectrometer of the present invention comprises an ion source, an ion guide and trap, two reflectrons, and a detector. The ion guide is connected downstream of the ion source and is disposed orthogonal to the ion accelerator. The first reflectron is a two stage gridless reflectron and it is disposed opposite the accelerator. The second reflectron is a single stage gridded reflectron and it is disposed opposite the first reflectron, in between the ion flight region and the detector.

In the present invention, part of the accelerator is a single trapping device which incorporates RF ion trapping and electrostatic ion extraction. The device comprises two types of electrodes—RF/DC electrodes, and DC electrodes. The RF/DC electrodes are preferably positioned parallel to one another, while the DC electrodes encompass the RF/DC electrodes. In a preferred embodiment, there are two sets of electrodes, each containing both the RF/DC electrodes and the DC electrodes. The sets of electrodes are arranged parallel and adjacent to one another. Also, within each set of electrodes, the RF/DC and DC electrodes are positioned in the same plane.

During normal operation of the multipole ion trap, the DC electrodes are held at a fixed DC potential. While trapping ions, the DC potential (i.e., the time averaged potential) on the RF/DC electrodes is held at a potential which is more attractive to the ions than the potential on the DC electrodes. Also, a preferred geometry of the device is such that the electrostatic field gradient produced by the electrodes is strong near the DC electrodes and virtually non-existent near the center. Also, the RF potentials applied to adjacent RF/DC electrodes are 180 degrees out of phase to repel ions toward the center of the multipole ion trap. During trapping, the potential applied to the DC electrodes must be of sufficient magnitude and the proper polarity to force ions toward the center of the trap. Preferably, the dimensions of the trap are chosen so that low energy ions (i.e., <0.1 eV) can be forced toward the center of the trap (i.e., to a region of 5 mm diameter) when trapping and the electrostatic field can be largely homogeneous during extraction.

To extract the ions from the multipole ion trap, the potentials on the RF/DC electrodes of each plane are held at two different fixed potentials. The potential difference between the planes accelerates the ions in a direction normal to the planes. The geometry, magnitude and the frequency of the potentials are crucial to the operation of the trap. The diameter of the planes and the gap between them should provide a small distribution of starting positions for the TOF analysis so that the potentials applied to the electrodes for extraction of the ions result in a short turn around time.

An object of the invention is to provide a multipole ion trap which, during extraction produces an ion beam having a width small enough (i.e., 5 mm in diameter) to be used with any conventional TOFMS devices. For example, the trap may be used with an RF/DC ion guide, and the planes of the electrodes of the ion guide are aligned parallel to the trap's electrodes and the center of the trap is aligned with the center of the guide. This arrangement allows the ions to move freely between the ion guide and the trap when the potential on the connecting (or gate) electrode is sufficiently low. This gate electrode can be closed by raising its potential to match that of the other DC electrodes. By slowly raising the gate potential, nearby ions will be forced into the trap without maintaining a significant amount of kinetic energy. The potential on the gate electrode is then maintained at the potential of the DC electrodes during the trapping and extracting process.

In accordance with the invention, the trap is preferably disposed between and parallel to two planar electrodes and comprises a fine conducting mesh. The accelerator portion comprises guard ring electrodes and a gridded electrode which are aligned parallel to one another and spaced at regular intervals. While trapping, the electrodes adjacent to the trap are held at neutral potentials. At this potential, there should be no significant influence of these electrodes on the ions in the trap.

Conversely, during the extraction process, the planar electrode between the guide and the trap is pulsed to a repulsive potential, while the electrode between the trap and the accelerator is pulsed to an attractive potential. This generates a homogenous electric field with the same field gradient as that of the trap. The ions then pass through the electrode nearest the guide and can be accelerated by the electric field generated by the guard rings and gridded electrodes. In the accelerator portion, the electrodes are electrically connected by an RC network.

An object of the multipole ion trap according to the present invention is to provide simplified and more efficient transfer ion optics than conventional ion traps and ion guides, as well as prior art orthogonal TOF mass spectrometers. Another object of the invention is to provide a multipole ion trap having no significant dependence on the m/z range of the instrument on the timing between the gate and accelerator pulses as in prior art instruments. Yet another object of the invention is to provide a multipole ion trap in which there is no dependence of transmission efficiency through the analyzer on the potential on a deflector often used in conventional instruments. Yet a further object of the invention is to provide a multipole ion trap wherein, in a given ion extraction, more ions can be extracted and analyzed than by conventional means and methods. In particular, in accordance with the present invention, all (or substantially all) of the ions within the trap will be extracted in a single pulse.

Other advantages of the present invention over prior art include improved resolution in the TOF analyzer and the elimination of correction for the initial orthogonal kinetic energy. These advantages are the results of using truly thermal kinetic energy ions. The ions in the trap will have only thermal kinetic energies because the ions are not accelerated between the ion guide and trap.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 depicts a prior art hexapole ion trap according to Franzen U.S. Pat. No. 5,763,878;

FIG. 2 depicts a prior art quadrupole ion trap according to Franzen U.S. Pat. No. 5,763,878;

FIG. 3 is an overall schematic drawing of a time-of-flight mass analyzer incorporating the present invention;

FIG. 4 shows the preferred embodiment of the multipole ion trap as used with an ion accelerator for use in TOF mass spectrometry, according to the invention;

FIG. 5A shows a side view of the preferred embodiment of a multipole ion trap according to the present invention;

FIG. 5B shows a cross-sectional view of the multipole ion trap shown in FIG. 5A;

FIG. 6 depicts the multipole ion trap shown in FIGS. 4, 5A and 5B as used with an RF/DC ion guide;

FIG. 7 shows the multipole ion trap depicted in FIGS. 4, 5A and 5B as used for an electron capture dissociation (ECD);

FIG. 8 demonstrates the introduction of low energy electrons into the accelerator shown in FIG. 6 to produce negative ions from neutral gas phase molecules, in accordance with the invention;

FIG. 9 is a graph of signal intensity vs. pulse duration showing the intensity of the ion beam as a function of time during an extraction pulse of 20 microseconds using the accelerator and multipole ion trap depicted in FIGS. 5A, 5B and 6.

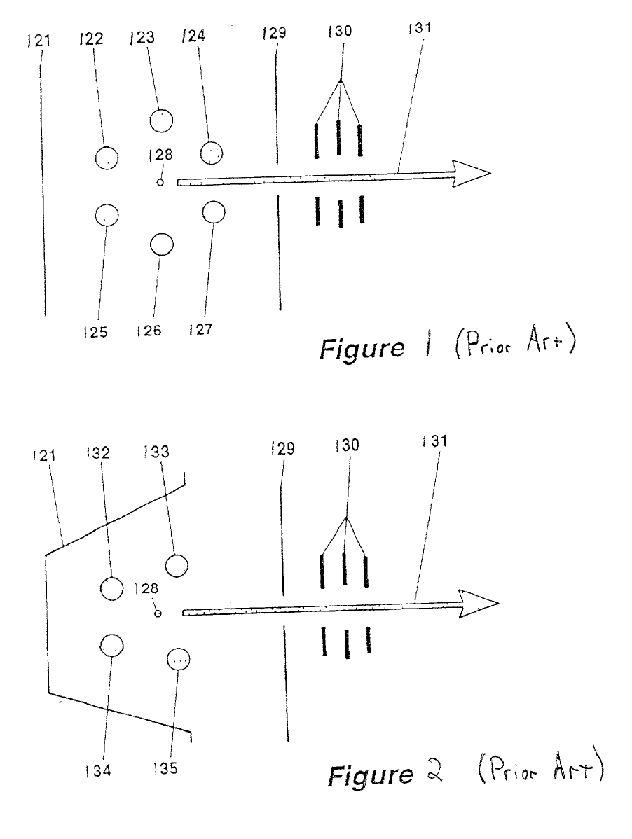

### DETAILED DESCRIPTION OF THE PREFERRED EMBODIMENT

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred 0 embodiment (as well as some alternative embodiments) of the present invention.

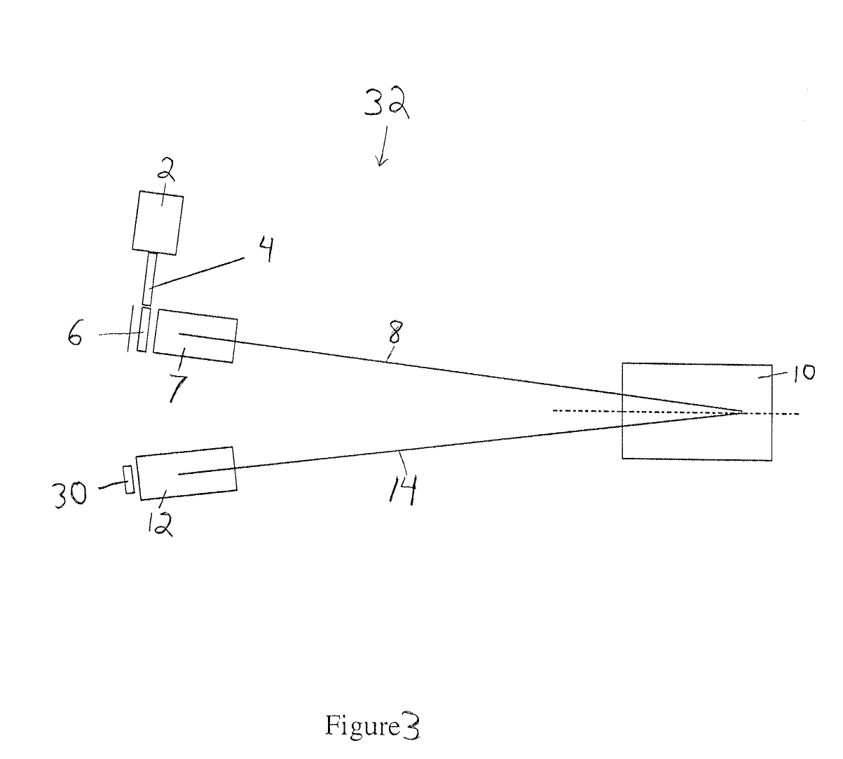

Referring first to FIG. 3, depicted is a schematic drawing of the preferred embodiment of a multipole ion trap orthogonal time-of-flight (TOF) mass spectrometer according to the invention. As shown, the (TOF) mass spectrometer 16 in accordance with the present invention includes ion production region 1, ion guide 2, accelerator/trap assembly 3, first flight tube/region 4, first ion reflector 5, second flight tube/region 7, second ion reflector 6, detector 15. Generally, ions are first generated in ion production region 1, which may be any known ionization means or method (i.e., electrospray ionization (ESI), plasma desorption ionization (PD), matrix assisted laser/desorption ionization (MALDI), electron ionization (EI), chemical ionization (CI), etc.). At some predetermined time after formation, the ions are accelerated into ion guide 2 which transports the ions to accelerator/trap 3. Ion guide 2 is preferably an RF/DC ion guide. For example, the RF/DC ion guide comprises a plurality of elongated electrode rods positioned around a central axis such that when RF & DC potentials are applied to the electrode rods, an electrostatic field is generated, thereby allowing the transmission of the ions through ion guide 2—from its entrance end (at ion production region 1) to ion accelerator/trap 3.

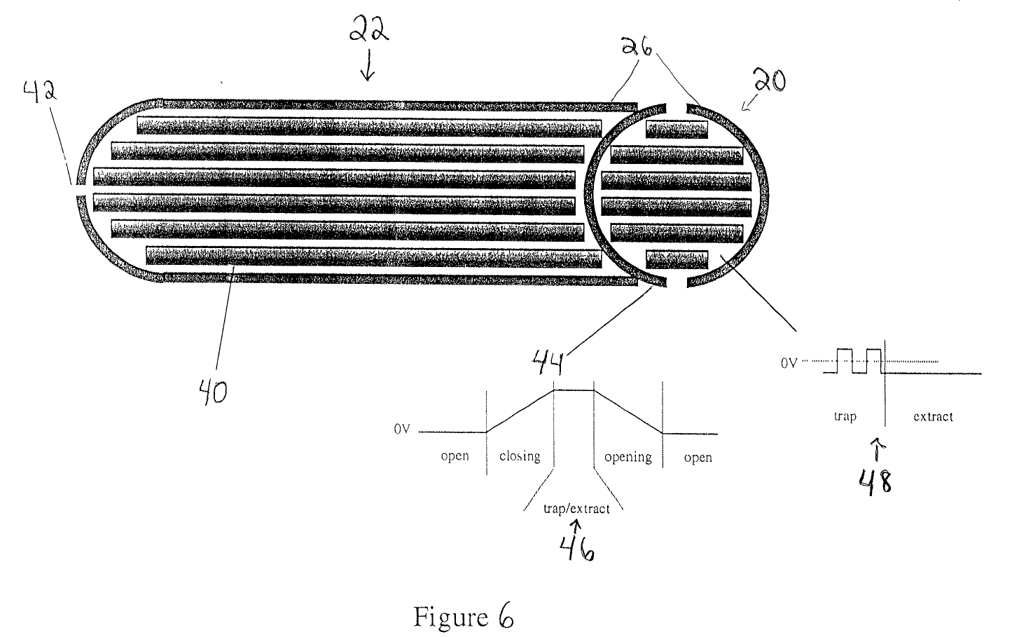

As the ions exit ion guide 2, they are introduced into accelerator/trap 3, which, as shown in FIG. 6, preferably comprises ion trap 10 (as further depicted in FIGS. 5A & 5B) disposed between and parallel to planar electrodes 17 & 18, a plurality of regularly spaced parallel guard ring electrodes 8 and gridded electrode 19 (which is aligned parallel to guard ring electrodes 8). Preferably, planar electrodes 17 & 18 are mesh gridded electrodes, but other forms of apertured electrodes may be used. The ions first reach ion trap 10 where, in a preferred embodiment, the ions are trapped for some predetermined time prior to orthogonal acceleration into the mass analyzer. Preferably, ion trap 10, as shown in FIGS. 5A and 5B, comprises two substantially parallel planar series of electrodes (i.e., each series of electrodes comprises, preferably, six RF/DC electrode rods 12 aligned in parallel and in a single plane, and two curved DC cap electrodes 13, as depicted in FIGS. 5A & 5B). Preferably, RF/DC electrode rods 12 are of lengths such that there parallel and planar alignment results substantially in a circular pattern. This allows curved DC cap electrodes 13 to substantially surround the ends of RF/DC electrodes 12—one DC cap electrode 13 at either end of RF/DC electrode rods 12. Of course, in accordance with the invention, ion trap 10 may comprise more or less than six RF/DC electrode rods 12.

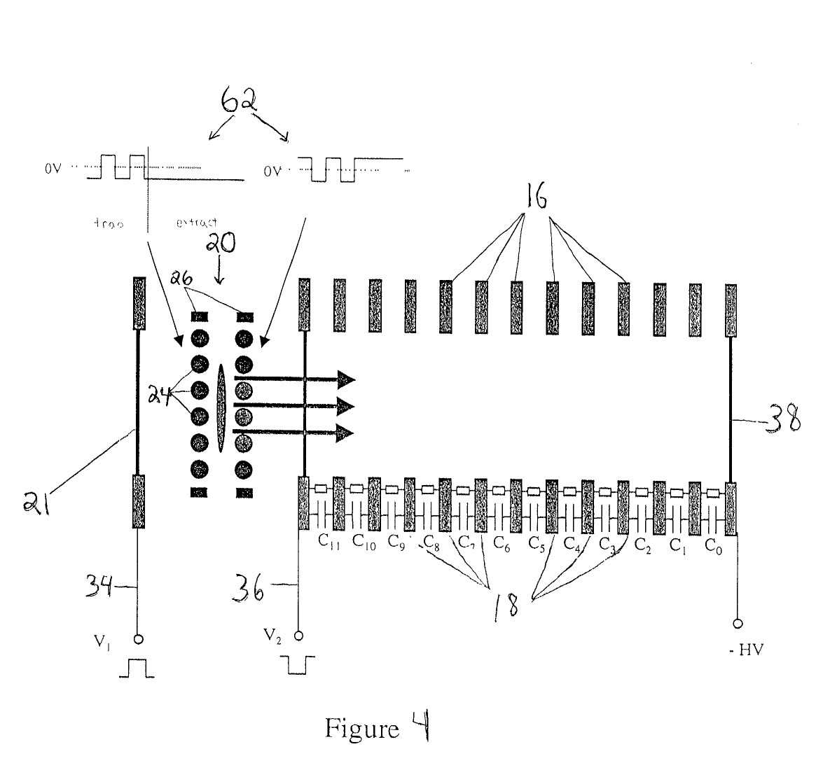

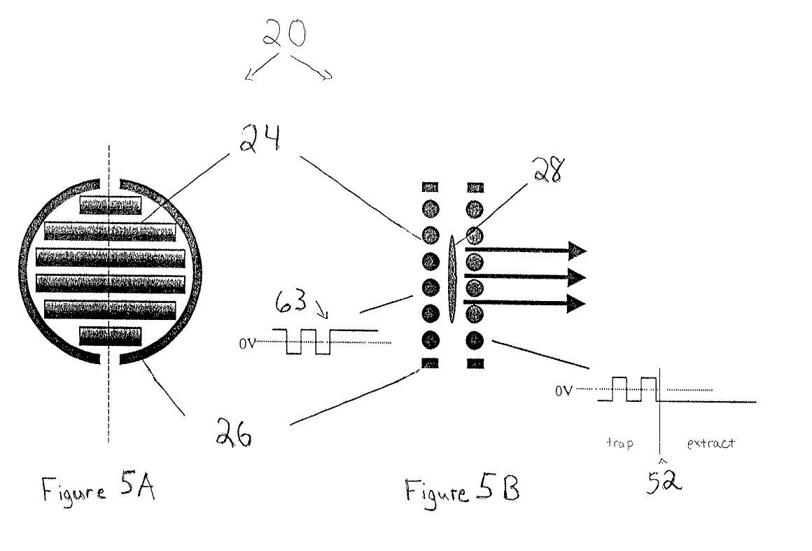

Depending upon the potential(s) applied to the electrodes of accelerator/trap 6 (see FIG. 4), the ions are either trapped therein or accelerated into flight tube/region 8 toward first reflector 10. As shown, accelerator/trap 6/7 is positioned such that ions may be transferred from ion trap 6 to TOF accelerator 7 which comprises guard ring electrodes 16 and gridded electrodes 36 and 38.

Referring now to multipole ion guide 22, as depicted in FIG. 6, a preferred embodiment of multipole ion guide 6 comprises of RF guide electrodes 40 and is connected to ion trap 20 by a gate electrode 44. As shown, the ion guide 22 is positioned such that ions coming from the entrance 42 may be transferred through the guide 22 and into trap 20 via the gate electrode 44. Diagram 46 in FIG. 6 shows how the potential on the gate electrode can be varied at the different stages of operation.

Turning now to ion trap 20, as depicted in FIGS. 5A and 5B, a preferred embodiment of ion trap 20 is shown comprising two sets of electrodes, RF/DC electrodes 24 and DC electrodes 26. Each set consists of RF/DC electrodes 24 arranged parallel to one another and DC electrodes 26 which encompass the RF/DC electrodes 24. The electrodes 24 & 26 of each set are arranged in parallel and adjacent planes. The device depicted in FIGS. 5A and 5B is only part of the larger accelerator/trap 6 instrument depicted in FIG. 3. As shown, the ions 28 are trapped in an elongated region at the center of the trap 20. Also, diagram 52 shows how the voltage will vary at each stage of operation of trap 20. At one stage of operation the ions 28 will exit the trap and enter the TOF accelerator as shown in FIG. 3.

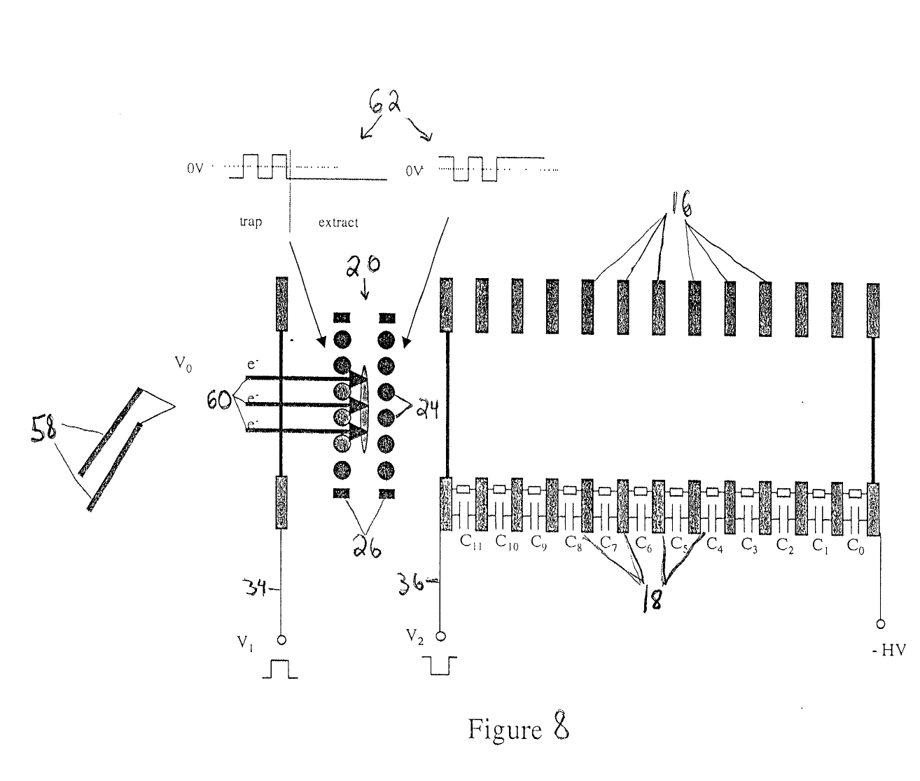

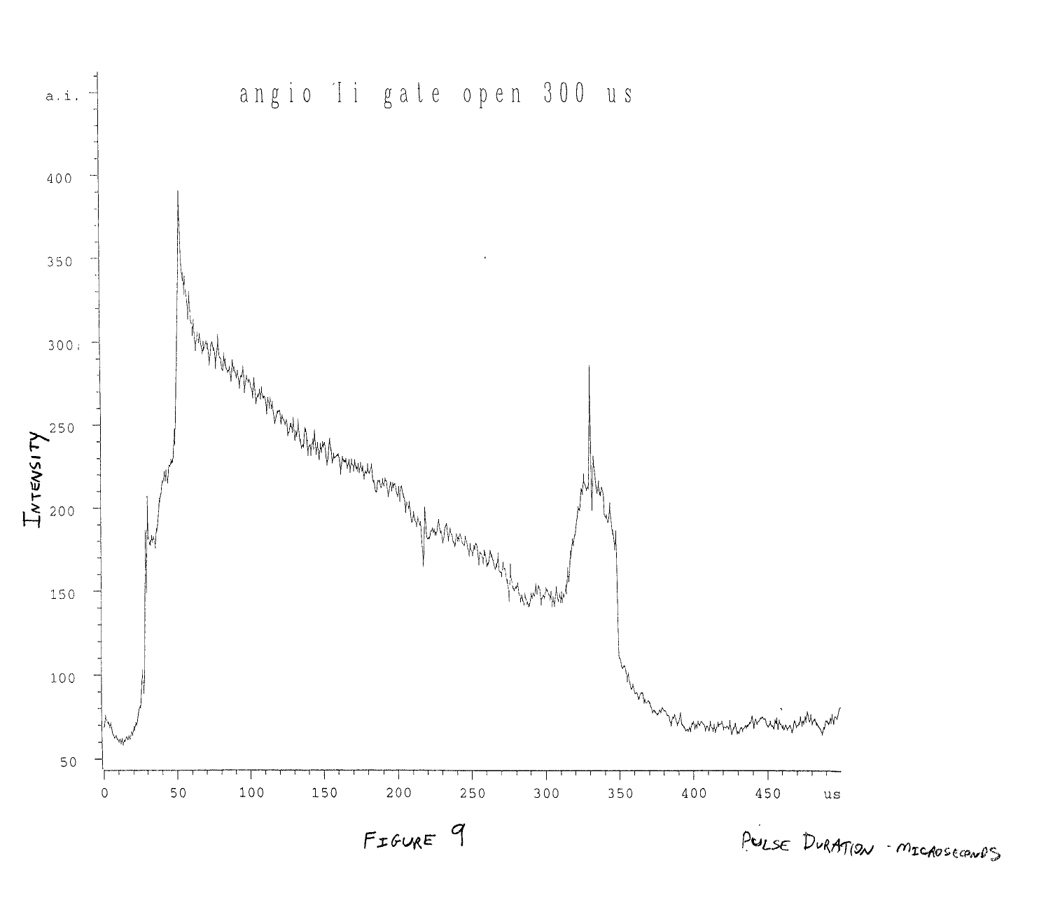

Next, FIG. 9 shows results of a prior art experiment involving ions ejected from a multipole ion guide having a pulsed exit aperture. The ions were trapped in a multipole ion guide by applying a repelling potential on the apertured electrode at its exit. A pulse of ions is produced for analysis by pulsing the aperture electrode. Ions may exit the multipole (in this case a hexapole) and enter the detector for the duration of the pulse. FIG. 8 depicts the intensity of the ion beam as a function of time during an extraction pulse of 20 us. Only a certain fraction of the ions extracted from the multipole will be between the repeller and grid simultaneously and only that fraction will be useful in the TOF analysis. The extraction duration is selected to optimize this fraction of useful ions.

During operation, ions 28 are generated by the ion production region 2 and are introduced to the accelerator/trap 6 via multipole ion guide 4. The region near the ion entrance 42 is filled with neutral gas held at moderate pressure to cool the ions to thermal energies. The pressure of the gas near the trap 20 is relatively low compared to the pressure near the entrance region. The potential on the gate electrode 44 is held at a potential near ground and ions 28 can pass from the guide to the trap. As shown in FIG. 6, the gate 44 potential can be closed by slowly raising its potential until it is the same potential as the other DC electrodes 26. The ions 28 will not be able to enter the trap 20, and the trap/extract process may begin. If the potential energy is raised slowly enough, then the ions 28 forced into the trap 20 will not have significant kinetic energy.

After the ions 28 have passed the multipole guide 22 and entered the trap 20, the trap 20 is turned on and the ions 28 are forced into an elongated region near its center. As depicted in FIGS. 5A and 5B, the electrodes 24 & 26 and their placement in the trap 20 is out of proportion and is intended only to illustrate the concept of trapping and extracting ions 28 according to the present invention. In a more practical example, the RF/DC electrodes 24 might have a diameter of 50 um and the gap between the planes might be 1 mm. The electrodes 24 need not be cylindrical but could be, for example, rectangular in cross section. The planes of RF/DC electrodes 24 might have a diameter of 10 mm. The DC electrodes 26 might have an inner diameter of 10.1 mm and be biased to a potential of 20 V to trap positive ions. During trapping mode operation, the RF potential applied to the RF/DC electrodes 24 might take the form of a square wave of a frequency of 5 MHZ, a peak-to-peak voltage of 200 V, and a time averaged potential of 0V. Adjacent RF/DC electrodes 24 within a given plane would experience potentials 180 degrees out of phase. During extraction mode operation, the RF/DC electrodes 24 of one plane would all be held at a DC potential of 100V whereas the potential applied to the opposite plane would be −100 V. The potential difference between the planes of electrodes 24 & 26 accelerates the ions 28 out of the trap 20 in a directions normal to the planes.

As shown in FIG. 4, the extracted ions 28 are transferred into the TOF ion accelerator 16, 18 & 38. During ion trapping, the electrodes 34 & 36 are held at neutral potentials. During extraction, the potential on electrode 34 is pulsed to a repulsive potential V1. The potential on electrode 36 is pulsed to an attractive potential V2. V1 and V2 are selected so as to produce a homogeneous field between electrodes 34 & 36. The pulsed voltage V2 and the DC potential −HV applied to either end (36 & 38, respectively) of the RC network 18 is divided and applied to the electrodes.

As depicted in FIG. 3, the ions 28 are accelerated by the TOF accelerator 7 toward reflectron 10. It is possible to use a two stage reflectron because of the relatively small diameter (5 mm) of the ion beam 8 and 14. In such case, the ions will then be reflected towards the second reflectron 12 and eventually end up in the detector 30. However, alternatively the MIT-OTOF may take the form of a linear reflectron instrument (i.e., without the second reflectron, or with two coaxial reflectrons.

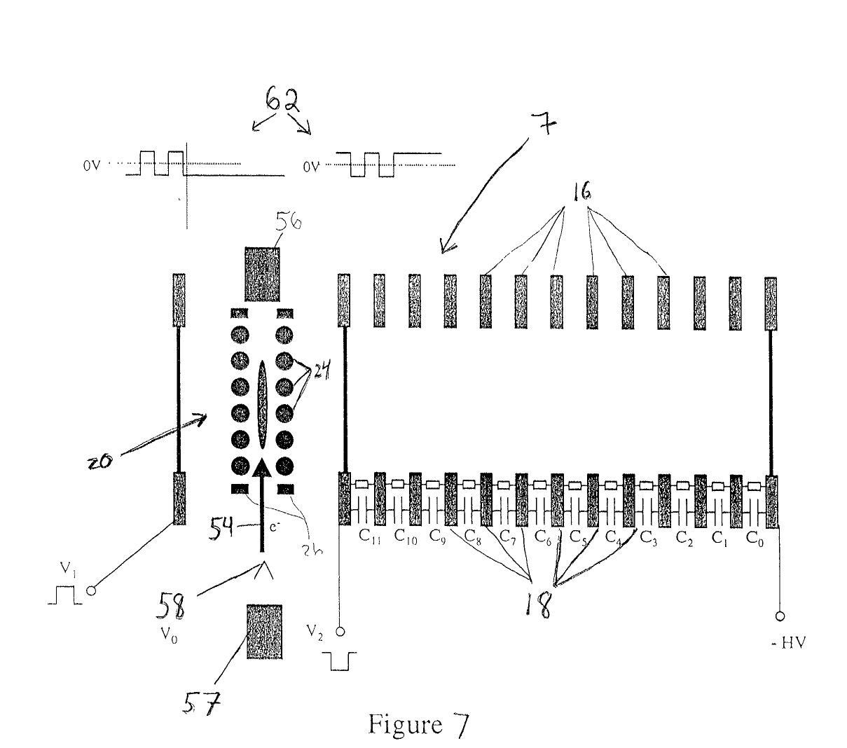

Next, FIG. 7 shows an alternate embodiment of multiple ion trap 20 according to the present invention depicting the use of ion trap 20 with electron capture dissociation (“ECD”). ECD is a method of forming fragment ions from multiply and positively charged ions. Specifically, the ions capture low energy electrons 54. The formed fragments can be analyzed to reveal structurally useful information about the original ion. A detailed discussion of the ECD method is given by R. A. Zubarev, J. Amer. Chem. Soc., 120, 3265 (1998) et al. As shown in FIG. 7, electrons 54 are injected in a direction parallel and between the two planes of trap electrodes 24 & 26 and perpendicular to the axis of accelerator 7, the analyzer (not shown) and the ion guide (not shown). The DC electrodes 26 are held at a positive DC potential during the trapping stage, and the injected electrons 54 are accelerated and decelerated by the DC electrodes 26 as they enter the trap 20. Magnets 56 and 57 are used to help direct the electrons 54 into trap 20. Slits (not shown) may be used between the electron filament 58 and trap 20 to remove divergent portions of the electron beam. Alternatively, the electron beam could be energy filtered before injection into trap 20. Also, higher energy electrons might be used to ionize neutral molecules in trap 20. It is possible to produce and inject the low energy electrons required by ECD into trap 20 because the kinetic energy of the ions in trap 20 is the same as before they entered trap 20.

Turning next to FIG. 8, shown is yet another alternate embodiment of multiple ion trap 20 according to the present invention. FIG. 8 depicts low energy electrons 60, from filament 58, used to produce negative ions from neutral gas phase molecules. As shown in FIG. 8, the electrons 60 are produced using filament 58 and introduced from the back of the ion trap 20 since negative ions are to be produced and DC electrodes 26 would have to be held at negative potentials if the ions were to be introduced through the top or bottom of trap 20. Electrons 60 will have low kinetic energies and will be able to pass into multiple ion trap 20 only when the potential on RF/DC electrodes 24 is near zero volts. The RF potential applied to RF/DC electrodes 24 might be varied from the square wave depicted in diagram 62 of FIG. 8 so that RF/DC electrodes 24 are near ground potential for a longer period of time. Other waveforms may be used to enhance the transmission of electrons 60 into trap 20, or to reduce the electron energy once in trap 20. Once in trap 20, electrons 60 may ionize molecules according to the “reversal electron attachment” (“READ”) method. To assist in the READ process, a potential difference may be applied between the two planes of RF/DC electrodes 24 as well as between adjacent RF/DC electrodes 24 to “slow down” electrons 60 and then turn them around while in trap 20. This

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. An apparatus for transferring ions from an ion source to a time-of-flight mass analyzer, said apparatus comprising:
an ion trap having a plurality of poles arranged to form two parallel adjacent planes, said planes perpendicular to the axis of said mass analyzer;
a multipole ion guide; and
a trap electrode positioned between said ion guide and said ion trap;
wherein an RF potential is applied to at least one of said plurality of poles, and wherein a substantially DC potential is applied to at least one of said plurality of poles, and wherein the distance between said parallel planes is substantially greater than the distance between poles within said planes such that substantially no electric field is present within the area between said parallel planes.
